(19) United States
(12) Patent Application Publication
(10) Pub. No.: US 2013/0325678 A1
(43) Pub. Date: Dec. 5, 2013

(54) RISK PROFILING FOR SERVICE CONTRACTS

(71) Applicants: Winnie W. Cheng, Yorktown Heights, NY (US); Henry Hu, Yorktown Heights, NY (US); James Moulic, Yorktown Heights, NY (US); Arjun Natarajan, Yorktown Heights, NY (US); Shu Tao, Yorktown Heights, NY (US)

(72) Inventors: Winnie W. Cheng, Yorktown Heights, NY (US); Henry Hu, Yorktown Heights, NY (US); James Moulic, Yorktown Heights, NY (US); Arjun Natarajan, Yorktown Heights, NY (US); Shu Tao, Yorktown Heights, NY (US)

(73) Assignee: International Business Machines Corporation, Armonk, NY (US)

(21) Appl. No.: 13/483,198

(22) Filed: May 30, 2012

(51) Int. Cl. G06Q 40/00

(52) U.S. Cl. 705/35

(57) ABSTRACT

A method for profiling information technology (IT) service contract risks and generating contract prices includes analyzing historical IT service contract risk data to create a set of IT service contract risk profiles, where the historical IT service contract risk data includes contract risks and percent gross profit associated with a historical set of contracts, where each IT service contract risk profile is a probability distribution function of achieving a percent gross profit associated with a subset of contracts corresponding to particular set of contract risk values, and creating a mapping between a particular IT service contract risk profile and a new IT service contract associated with the set of contract risk values for the IT service contract risk profile to determine an optimum price for the new IT service contract.

### BACKGROUND

1. Technical Field

The present disclosure is directed to systems and method for managing financial risk in information technology (IT) service contracts.

2. Discussion of Related Art

Information technology (IT) services are long-running projects governed by a myriad of factors throughout their lifetime. The goal of service management is to ensure uninterrupted delivery of service from the provider to the customer, while meeting a number of quality and performance goals. The objectives of a service provider are to maintain good service quality, high client satisfaction, and ultimately continuous profitability of its contracts.

Service companies are facing ever-increasing risks in service contracts due to uncertain economic situations. Because service contracts typically span multiple years and could cover various aspects of IT services, numerous derailments can occur during their lifetime. Although some of these derailing risk factors are unpredictable before a contract enters delivery phase, many risk factors do have early signs that can be detected. For example, a provider dealing with a customer who has not been in good financial situations is more likely to have financial troubles for this contract.

From a service provider's perspective, it is important to develop mechanisms to identify these potential risks before the contract is signed. Some of these risk factors can be mitigated through various risk management practices, while the others will remain until the contract enters delivery. The only leverage the provider has at that time is pricing. That is, a provider can negotiate for higher price for high-risk projects, so that the overall profitability of a portfolio of contracts can be maintained.

Analysis has shown that majority of the “troubled” contracts were due to insufficient handling of engagement risks, such as a lack of understanding of client environment, a misunderstanding the service delivery scope or objectives, poor resource planning and management, etc. Engagement risks have direct impact on contract profitability, e.g., the difference between the actual and the planned gross profit.

While preparing for a contract, a question that arises is “what is the fair price for this contract?” The fair price should be determined by the overall profitability target and the risk appetite of the company. The profitability target can be, for example, a certain gross profit margin that needs to be achieved in one or multiple years. The risk appetite is the tolerance of a certain probability of not being able to achieve the target, and the worst-case profit achieved.

### BRIEF SUMMARY

According to an aspect of the invention, a method for profiling information technology (IT) service contract risks and generating contract prices includes analyzing historical IT service contract risk data to create a set of IT service contract risk profiles, where the historical IT service contract risk data includes contract risks and percent gross profit associated with a historical set of contracts, where each IT service contract risk profile is a probability distribution function of achieving a percent gross profit associated with a subset of contracts corresponding to particular set of contract risk values, and creating a mapping between a particular IT service contract risk profile and a new IT service contract associated with the set of contract risk values for the IT service contract risk profile to determine an optimum price for the new IT service contract.

According to another aspect of the invention, a method for profiling information technology (IT) service contract risks and generating contract prices includes training a classifier that classifies a set of historical IT service contracts into distinct subsets according to a hierarchy of risk factors, where at each level of the hierarchy of risk factor, an IT service contract is classified into two or more categories based on that contract's risk value or range of values for that risk factor, where each subset of historical contracts is associated with a particular combination of risk factors and risk factor values, and compiling gross profit data of all IT service contracts of each subset of IT service contracts to compute a gross profit probability distribution function for the IT service contracts of each subset of IT service contracts associated with that particular set of contract risk factors and risk factor values.

According to another aspect of the invention, a computer program storage medium readable by a computer, tangibly embodying a program of instructions executed by the computer may perform the method steps for profiling information technology (IT) service contract risks and generating contract prices.

### BRIEF DESCRIPTION OF THE SEVERAL VIEWS OF THE DRAWINGS

FIG. 1 is a table of risk factors, according to an embodiment of the invention.

FIG. 2 is a graph illustrating predicted profitability distributions before and after mitigating risk factors, according to an embodiment of the invention.

FIG. 3 is a flowchart of a method for profiling contract risks and generating pricing recommendations according to an embodiment of the invention.

FIG. 4 illustrates an example of a risk profile classifier, according to an embodiment of the invention.

FIGS. 5(a)-(d) are a series of graphs that illustrate the relationship between risk profile and price contingency, according to an embodiment of the invention.

FIG. 6 illustrates an example of an optimal price calculation, according to an embodiment of the invention.

FIG. 7 is a block diagram of an exemplary computer system for implementing a method for profiling contract risks and generating pricing recommendations according to an embodiment of the invention.

### DETAILED DESCRIPTION

Exemplary embodiments of the invention as described herein generally include systems and methods for estimating the profit distribution of a contract, given its assessed risks, before contract is signed, and pricing the contract based on the estimated profit distribution. Accordingly, while the invention is susceptible to various modifications and alternative fauns, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention.

The difference between a low risk and a high risk contract is in the probability distribution for achieving a certain profit. For example, a low risk contract has a “tighter” distribution, or less (in particular, down-side) variability in its profitability, while a high risk contract has a “wider” distribution or more variability in its profitability outlook. A base price can be determined by the estimated cost of delivering the contract, plus the target profit. For risky contracts, the variability in its profitability outlook comes from the fact its delivery cost may be underestimated. If the risks cannot be mitigated, then to compensate for such risks, a common approach is to increase the price, or to add “price contingency”. Without changing other aspects of a contract, the effect of adding price contingency is to shift the profitability distribution, so that the probability of achieving or exceeding a certain profit x, P(profit>=x), can be increased. Assuming everything else is the same, a higher risk contract needs more price contingency to achieve the same P(profit>=x), than a lower-risk contract.

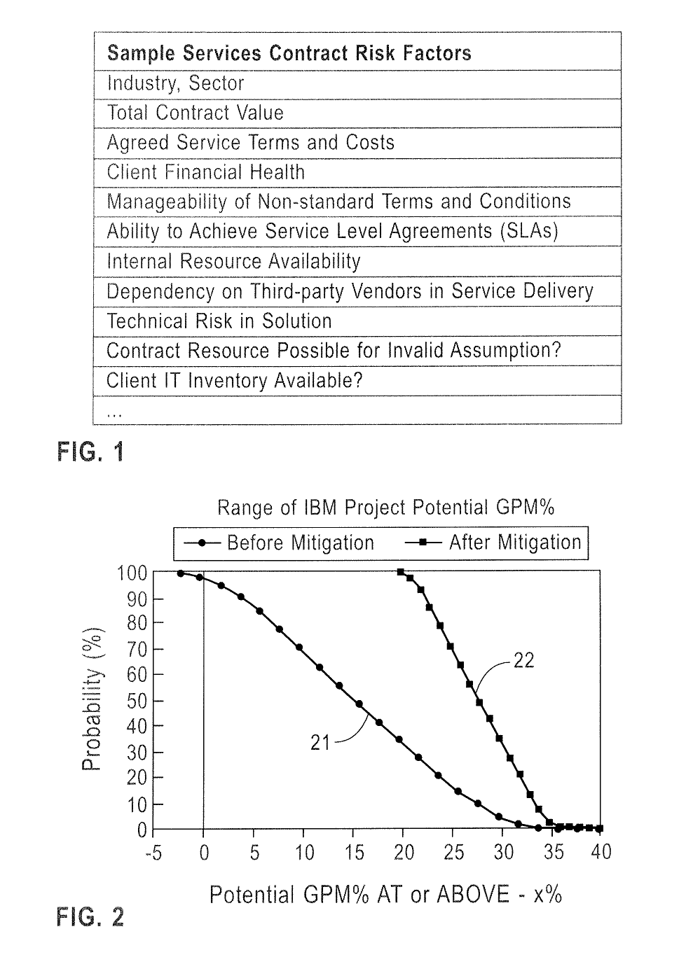

Exemplary embodiments of the invention mine historical risk data to identify the key risks that contribute to financial losses in service contracts. Risk factors are identified and quantified through human input, such as questionnaires, in combination with text mining from standard documents, such as contract documents. Iterative and repeatable mining is needed due to the ever-changing environment in the service industry. A list of risk factors associated with service contracts includes service requirements, contract terms and conditions, delivery resources, technical solutions, the client environment, cost and budget, etc. Additional risk factors are listed in the table of FIG. 1. Embodiments of the invention assume that a business performing these type of analytics to analyze and predict the type of contracts the business signs with its own customers/service vendors, so that past data regarding expected and actual profit margins and risk factors will be available. Output from a risk assessment system according to an embodiment of the invention include predictions on financial outcome given the risk assessment, pricing adjustment recommendations based on the financial outcome prediction, and the capability of doing “what-if” analysis: assuming some risks can be mitigated, recreate the predicted outcome with this risk adjustment, and for those risks that cannot be mitigated, determining an appropriate price contingency to build into the contract price.

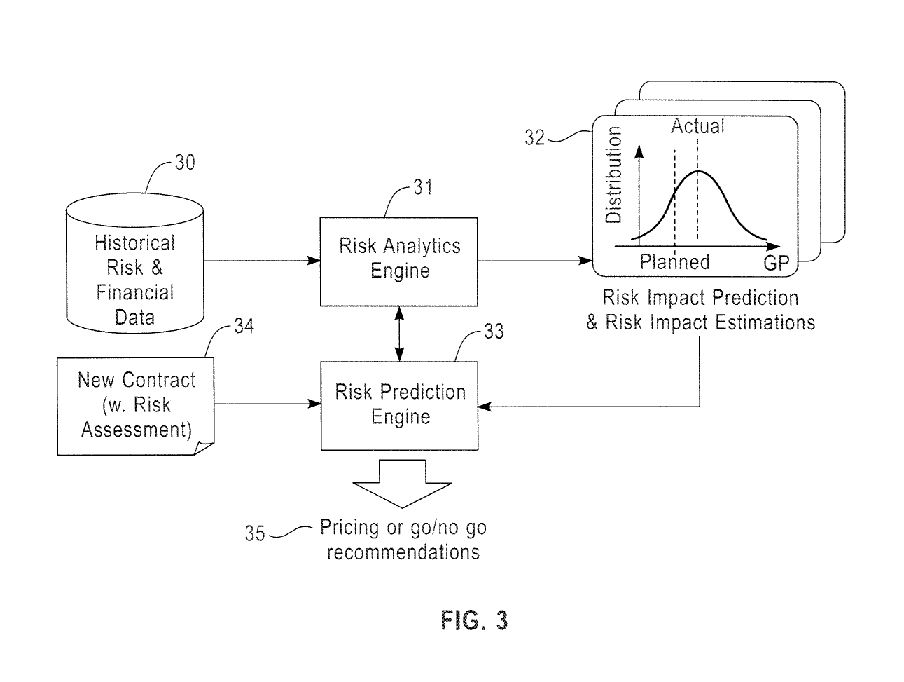

Contract risk profiling uses the identified risk factors to create profiles that can be matched with newly signed contracts. A method for profiling contract risks and generating pricing recommendations according to an embodiment of the invention includes the following steps, illustrated in the flowchart shown in FIG. 3. First, at step 31, a set of contract risk profiles are created by analyzing historical contract risk data. The historical data should include two pieces of information: contract risks and percent gross profit. As shown in FIG. 3, contract risks can be obtained from various data sources 30, such as existing risk management systems, proposal reviews, financial data, etc. The gross profit percentage could come from the financial or accounting data for finished contracts. Given these data, contract risk profiling is performed by a Risk Analytics Engine, which is classifier that uses contract risks and percent gross profits as input attributes and generates a set of GP profiles 32 as output. According to an embodiment of the invention, the classifier can be represented as a regression tree, in which each node represents a particular value or range of factors fort a single risk factors, and the final number of categories is determined by the number of leaf nodes. A classifier according to an embodiment of the invention performs supervised learning driven by the actual gross profit percentages. Each profile is an empirical or modeled GP distribution associated with a set of risk factors, which represents the range of possible profits that can be earned from a contract in this profile.

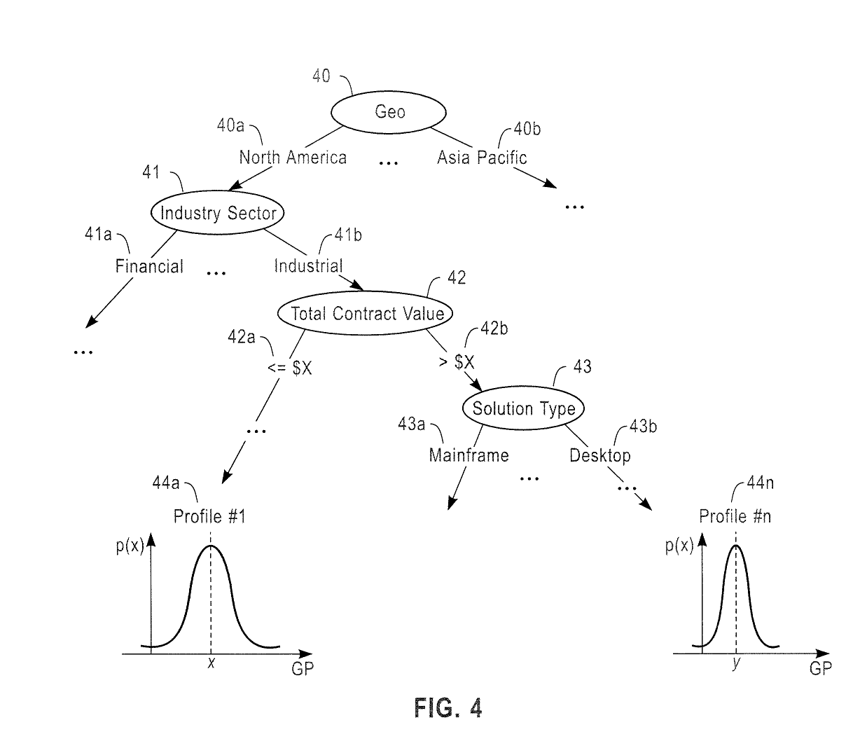

An example of a regression tree risk profile classifier according to an embodiment of the invention is shown in FIG. 4. Each node in the regression tree represents a category by which a contract can be classified. For example, an exemplary, non-limiting top level category could be the geographical locality of the service provider who is party to the contract, as represented by node 40. In the example of FIG. 4, two possible choices are depicted for ease of illustration: North America 40a and the Asia-Pacific region 40b. However, regression tree risk profile classifiers according to embodiments of the invention are not limited to a binary tree as shown in FIG. 4, and each node can be associated with two or more choices in other embodiments of the invention. Returning to FIG. 4, an exemplary, non-limiting category for a next level of classification is the industry sector 41 of the other party to the contract, for which two choices are depicted: Financial 41a and Industrial 41b. One the industry sector has been determined, an exemplary, non-limiting third level classification category is the total contract value 42, for which two categories are displayed: <=$X 42a, and >$X 42b. Again, the binary choice is exemplary, and in other embodiments of the invention, the contract value could be categorized by a plurality of ranges of total value. A fourth exemplary, non-limiting classification category is the solution type 43, for which two possibilities are shown: a mainframe computer implementation 43a and a desktop computer implementation 43b. This type of classification can be continued until each contract has been classified according to all relevant categories. Note that in some embodiments, different branches of the regression tree can have different categories at the same level. For example, it could be the case that contracts whose total value is <=$X are always implemented on desktop computers, thus a classification according to solution type would be omitted for those types of contracts, and a different category would be classified at the fourth classification level for contracts whose total value is <=$X. In addition to those risk factors used in the figure, other risk factors include whether there is a standard or non-standard technical solution for the contract, the experience level of the delivery team of the service provided party to the contract, the client's financial health, the service level agreement attainability, etc. Once every previous or current contract has been classified according to its risk factors, the gross profits of the contracts for each combination of risk factor classifications are compiled so that a gross profit probability distribution function (pdf) for each combination of risk factor classifications can be calculated, as indicated by profile 44a and profile 44n.

Given a matched contract risk profile, the individual impact of each key risk can be predicted, as well as the aggregated impact on overall profitability, in actual dollars of a gross profit percentage. With such prediction, a user can: (1) determine those risks that can be mitigated; (2) project profitability and adjust pricing to compensate for risks; and (3) review risk insights. For those risks that can be mitigated, an expert can assign new risk factor values for the mitigated IT service contract and the classifier can reclassify the IT service contract according to the new risk factor values. FIG. 2 is a graph illustrating predicted profitability distributions before 21 and after 22 mitigating risk factors. The effect of mitigating risk is to change the risk factor classifications so that a higher percentage of contracts achieve a desired GP percentage.

Referring again to FIG. 3, at step 33, given an existing contract portfolio and its expected GP target, a Risk Prediction Engine is developed, which is a price contingency model, to create a mapping between a new contract, which is associated with a certain profile and will be added to this contract portfolio, and its corresponding price.

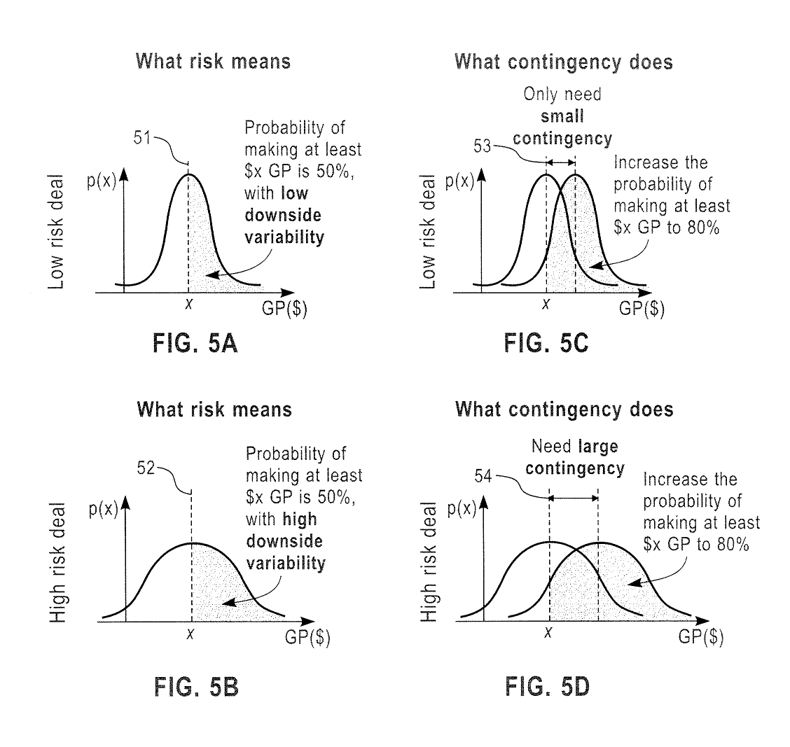

FIGS. 5(a)-(d) illustrate the relationship between a risk profile and a price contingency. FIG. 5(a) is a graph of the pdf of a low risk contract, plotted as a function of gross profit GP. The dotted line 51 at x on the GP axis indicates the point on the pdf in which the probability of earning at least $x is 50%. The pdf in FIG. 5(a) has relatively small standard deviation, corresponding to a low downside variability. FIG. 5(b) is a graph of the pdf of a high risk contract, plotted as a function of gross profit GP, with the dotted line 52 indicating the point on the pdf in which the probability of earning at least $x is 50%. The pdf in FIG. 5(b), having a broader peak and a larger standard deviation than the pdf in FIG. 5(a), has a high downside variability. FIGS. 5(c) and 5(d) illustrate the effects of contingency for the respective situations illustrated in FIGS. 5(a) and 5(b). In FIG. 5(c), since the pdf of FIG. 5(a) has a relatively narrow peak, only a small contingency 53 is needed to increase the probability of earning at least $x from 50% to 80%. On the other hand, since the pdf of FIG. 5(b) has a relatively broad peak, a larger contingency 54 is needed to increase the probability of earning at least $x from 50% to 80%. In both cases, the price contingency can be determined from the standard deviation, e.g., by adding a price corresponding to the displacement along the GP axis due to the standard deviation of the distribution.

In the above pricing scenario, all parameters, such as profit target, risk appetite, estimated delivery cost, etc., can be determined, except for the profitability distribution of the new contract to be signed.

A risk profiler according to an embodiment of the invention can use the empirical profitability distribution output from the Risk Analytics Engine classifier based on all historical contracts in the same class or profile as this new contract. With this distribution and the other input parameters, one can compute an optimal price contingency to be added to the price, given a certain target of P(profit>=x). For example, suppose the current portfolio has n contracts belonging to up to k profiles, where k is the maximum number of profiles identified in step 31 of FIG. 3. If a new contract from profile p, where p is between 1 and k, is to be added to this portfolio, an optimal pricing for p can be calculated based on the GP distributions of each contract profile, because the probability of a contract having profile p earning certain a GP percentage is known from the profiling analysis. Note that such an optimization is only “locally optimal”. Because not all contracts are initiated at the same time, a globally optimal pricing for all contracts cannot be determined at one time.

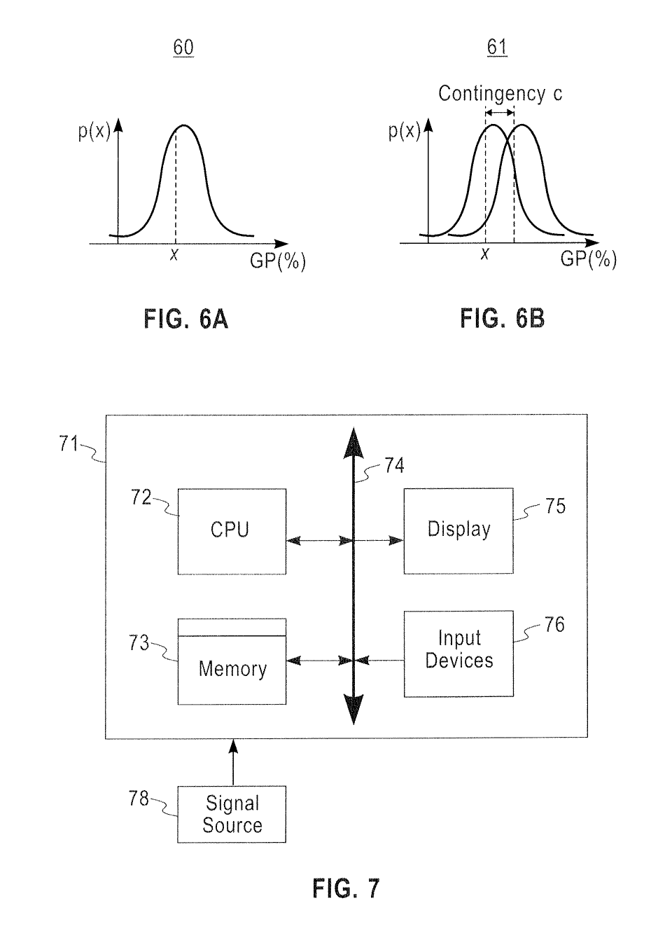

An example of an optimal price contingency calculation according to an embodiment of the invention is illustrated in FIG. 6. Referring to the figure, the inputs to a pricing model engine according to an embodiment of the invention would be the expected gross profit x for a new contract, a confidence level needed to sign the contract, e.g., 80%, and the gross profit margin pdf 60 associated with the set of risk factor classifications for the new contract. According to an embodiment of the invention, the gross profit margin pdf is assumed to have a normal distribution:

$$p ( x ) = \frac{1}{\sqrt{2 π} σ} exp ( - \frac{1}{2} {( \frac{x - μ}{σ} )}^{2} ) ,$$

where μ is the mean gross profit margin of the distribution, and σ is the standard deviation of the distribution. Then, the confidence or predicted probability of achieving a gross profit margin x is:

$$Φ ( x ) = \frac{1}{\sqrt{2 π} σ} {\int }_{x}^{∞} exp ( - \frac{1}{2} {( \frac{x - μ}{σ} )}^{2} ) d x .$$

In the present example, for which an 80% confidence level of achieving a gross profit of $x is needed to go forward with the contract, if Φ(x)<80%, a contingency, i.e. the amount of a price adder c, is needed to improve the confidence level to 80%: c=μ′−μ. The price adder c can be determined from the cumulative distribution integral:

$${Φ}^{′} ( x ) = \frac{1}{\sqrt{2 π} σ} {\int }_{x}^{∞} exp ( - \frac{1}{2} {( \frac{x - {μ}^{′}}{σ} )}^{2} ) d x = 80 \% .$$

This price adder c has the effect of shifting the gross profit margin pdf to the right on the gross profit (GP) axis by the amount c, as shown by graph 61.

Thus, referring again to FIG. 3, when a new contract 34 is proposed, a system according to an embodiment of the invention first determines its associated profile, and then uses the price contingency model to generate recommendations 35 in terms of what its optimal price should be for the contract portfolio, or whether a contract should be entered into at all.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

FIG. 7 is a block diagram of an exemplary computer system for implementing a method for profiling contract risks and generating pricing recommendations according to an embodiment of the invention. Referring now to FIG. 7, a computer system 71 for implementing the present invention can comprise, inter alia, a central processing unit (CPU) 72, a memory 73 and an input/output (I/O) interface 74. The computer system 71 is generally coupled through the I/O interface 74 to a display 75 and various input devices 76 such as a mouse and a keyboard. The support circuits can include circuits such as cache, power supplies, clock circuits, and a communication bus. The memory 73 can include random access memory (RAM), read only memory (ROM), disk drive, tape drive, etc., or a combinations thereof. The present invention can be implemented as a routine 77 that is stored in memory 73 and executed by the CPU 72 to process the signal from the signal source 78. As such, the computer system 71 is a general purpose computer system that becomes a specific purpose computer system when executing the routine 77 of the present invention.

The computer system 71 also includes an operating system and micro instruction code. The various processes and functions described herein can either be part of the micro instruction code or part of the application program (or combination thereof) which is executed via the operating system. In addition, various other peripheral devices can be connected to the computer platform such as an additional data storage device and a printing device.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the present invention has been described in detail with reference to exemplary embodiments, those skilled in the art will appreciate that various modifications and substitutions can be made thereto without departing from the spirit and scope of the invention as set forth in the appended claims.

What is claimed is:

1. A method for profiling information technology (IT) service contract risks and generating contract prices, comprising the steps of:
analyzing historical IT service contract risk data to create a set of IT service contract risk profiles, wherein the historical IT service contract risk data includes contract risks and percent gross profit associated with a historical set of contracts, wherein each IT service contract risk profile is a probability distribution function of achieving a percent gross profit associated with a subset of contracts corresponding to particular set of contract risk values; and
creating a mapping between a particular IT service contract risk profile and a new IT service contract associated with the set of contract risk values for said IT service contract risk profile to determine an optimum price for said new IT service contract.

2. The method of claim 1, wherein said historical IT service contract risk data is obtained by data mining historical IT service contract risk data to identify risks that contribute to financial losses in IT service contracts, wherein risk factors are identified and quantified through human input in combination with text mining contract documents.

3. The method of claim 1, wherein analyzing historical IT service contract risk data to create a set of IT service contract risk profiles further comprises training a classifier that classifies the set of IT service contracts according to a hierarchy of risk factors, wherein at each level of said hierarchy of risk factors, a contract is classified into two or more categories based on that contract's risk value or range of values for that risk factor.

4. The method of claim 3, wherein said hierarchy of risk factors is represented by a regression tree, wherein each node of said regression tree represents a risk factor, and wherein a child node is associated with each category associated with the risk factor, and wherein each leaf node of the regression tree corresponds to one of the particular sets of contract risk values associated with each contract risk profile probability distribution function.

5. The method of claim 4, further comprising compiling gross profit data of all IT service contracts associated with the particular set of contract risk values corresponding to each leaf node to compute the gross profit probability distribution function for the IT service contracts associated with that particular set of contract risk values.

6. The method of claim 1, wherein creating a mapping between a particular IT service contract risk profile and a new IT service contract comprises determining a IT service contract risk profile associated with said new contract, and calculating a confidence of achieving an expected gross profit x using the probability distribution function for the IT service contract risk profile associated with said new IT service contract, wherein if said calculated confidence is less than a minimum confidence required to proceed with said new IT service contract, calculating a price contingency to be added to a price of said IT service new contract to raise the calculated confidence to the minimum confidence.

7. The method of claim 6, wherein calculating a confidence of achieving expected gross profit x comprises calculating
$$Φ ( x ) = \frac{1}{\sqrt{2 π} σ} {\int }_{x}^{∞} exp ( - \frac{1}{2} {( \frac{x - μ}{σ} )}^{2} ) d x ,$$
wherein
$$p ( x ) = \frac{1}{\sqrt{2 π} σ} exp ( - \frac{1}{2} {( \frac{x - μ}{σ} )}^{2} )$$
is the probability distribution function, μ is a mean gross profit margin of the distribution, and σ is a standard deviation of the distribution.

8. The method of claim 7, wherein calculating a price contingency comprises determining a value c wherein
$${Φ}^{′} ( x ) = \frac{1}{\sqrt{2 π} σ} {\int }_{x}^{∞} exp ( - \frac{1}{2} {( \frac{x - ( c + μ )}{σ} )}^{2} ) d x$$
is equal to the minimum confidence required to proceed with said new contract.

9. A method for profiling IT service contract risks and generating contract prices, comprising the steps of:
training a classifier that classifies a set of historical IT service contracts into distinct subsets according to a hierarchy of risk factors, wherein at each level of said hierarchy of risk factor, an IT service contract is classified into two or more categories based on that contract's risk value or range of values for that risk factor, wherein each subset of historical contracts is associated with a particular combination of risk factors and risk factor values; and
compiling gross profit data of all IT service contracts of each subset of IT service contracts to compute a gross profit probability distribution function for the IT service contracts of each subset of IT service contracts associated with that particular set of contract risk factors and risk factor values.

10. The method of claim 9, further comprising using said classifier to determine an IT service contract risk profile associated with a new IT service contract, and calculating a confidence of achieving an expected gross profit x using the probability distribution function for the IT service contract risk profile associated with said new IT service contract, wherein if said calculated confidence is less than a minimum confidence required to proceed with said new IT service contract, calculating a price contingency to be added to a price of said new IT service contract to raise the calculated confidence to the minimum confidence.

11. The method of claim 9, wherein data associated with the set of historical IT service contracts includes contract risk data and percent gross profits.

12. The method of claim 10, wherein calculating a confidence of achieving expected gross profit x comprises calculating
$$Φ ( x ) = \frac{1}{\sqrt{2 π} σ} {\int }_{x}^{∞} exp ( - \frac{1}{2} {( \frac{x - μ}{σ} )}^{2} ) d x ,$$
wherein
$$p ( x ) = \frac{1}{\sqrt{2 π} σ} exp ( - \frac{1}{2} {( \frac{x - μ}{σ} )}^{2} )$$
is the probability distribution function, μ is a mean gross profit margin of the distribution, and σ is a standard deviation of the distribution, and calculating a price contingency comprises determining a value c wherein
$${Φ}^{′} ( x ) = \frac{1}{\sqrt{2 π} σ} {\int }_{x}^{∞} exp ( - \frac{1}{2} {( \frac{x - ( c + μ )}{σ} )}^{2} ) d x$$
is equal to the minimum confidence required to proceed with said new contract.

13. A computer program storage medium readable by a computer, tangibly embodying a program of instructions executed by the computer to perform the method steps for profiling information technology (IT) service contract risks and generating contract prices, the method comprising the steps of:
analyzing historical IT service contract risk data to create a set of IT service contract risk profiles, wherein the historical IT service contract risk data includes contract risks and percent gross profit associated with a historical set of contracts, wherein each IT service contract risk profile is a probability distribution function of achieving a percent gross profit associated with a subset of contracts corresponding to particular set of contract risk values; and
creating a mapping between a particular IT service contract risk profile and a new IT service contract associated with the set of contract risk values for said IT service contract risk profile to determine an optimum price for said new IT service contract.

14. The computer program storage medium of claim 13, wherein said historical IT service contract risk data is obtained by data mining historical IT service contract risk data to identify risks that contribute to financial losses in IT service contracts, wherein risk factors are identified and quantified through human input in combination with text mining contract documents.

15. The computer program storage medium of claim 13, wherein analyzing historical IT service contract risk data to create a set of IT service contract risk profiles further comprises training a classifier that classifies the set of IT service contracts according to a hierarchy of risk factors, wherein at each level of said hierarchy of risk factors, a contract is classified into two or more categories based on that contract's risk value or range of values for that risk factor.

16. The computer program storage medium of claim 15, wherein said hierarchy of risk factors is represented by a regression tree, wherein each node of said regression tree represents a risk factor, and wherein a child node is associated with each category associated with the risk factor, and wherein each leaf node of the regression tree corresponds to one of the particular sets of contract risk values associated with each contract risk profile probability distribution function.

17. The computer program storage medium of claim 16, the method further comprising compiling gross profit data of all IT service contracts associated with the particular set of contract risk values corresponding to each leaf node to compute the gross profit probability distribution function for the IT service contracts associated with that particular set of contract risk values.

18. The computer program storage medium of claim 13, wherein creating a mapping between a particular IT service contract risk profile and a new IT service contract comprises determining a IT service contract risk profile associated with said new contract, and calculating a confidence of achieving an expected gross profit x using the probability distribution function for the IT service contract risk profile associated with said new IT service contract, wherein if said calculated confidence is less than a minimum confidence required to proceed with said new IT service contract, calculating a price contingency to be added to a price of said IT service new contract to raise the calculated confidence to the minimum confidence.

19. The computer program storage medium of claim 18, wherein calculating a confidence of achieving expected gross profit x comprises calculating
$$Φ ( x ) = \frac{1}{\sqrt{2 π} σ} {\int }_{x}^{∞} exp ( - \frac{1}{2} {( \frac{x - μ}{σ} )}^{2} ) d x ,$$
wherein
$$p ( x ) = \frac{1}{\sqrt{2 π} σ} exp ( - \frac{1}{2} {( \frac{x - μ}{σ} )}^{2} )$$
is the probability distribution function, μ is a mean gross profit margin of the distribution, and σ is a standard deviation of the distribution.

20. The computer program storage medium of claim 19, wherein calculating a price contingency comprises determining a value c wherein
$${Φ}^{′} ( x ) = \frac{1}{\sqrt{2 π} σ} {\int }_{x}^{∞} exp ( - \frac{1}{2} {( \frac{x - ( c + μ )}{σ} )}^{2} ) d x$$
is equal to the minimum confidence required to proceed with said new contract.

21. A computer program storage medium readable by a computer, tangibly embodying a program of instructions executed by the computer to perform the method steps for profiling information technology (IT) service contract risks and generating contract prices, the method comprising the steps of:
training a classifier that classifies a set of historical IT service contracts into distinct subsets according to a hierarchy of risk factors, wherein at each level of said hierarchy of risk factor, an IT service contract is classified into two or more categories based on that contract's risk value or range of values for that risk factor, wherein each subset of historical contracts is associated with a particular combination of risk factors and risk factor values; and
compiling gross profit data of all IT service contracts of each subset of IT service contracts to compute a gross profit probability distribution function for the IT service contracts of each subset of IT service contracts associated with that particular set of contract risk factors and risk factor values.

22. The computer program storage medium of claim 21, the method further comprising using said classifier to determine an IT service contract risk profile associated with a new IT service contract, and calculating a confidence of achieving an expected gross profit x using the probability distribution function for the IT service contract risk profile associated with said new IT service contract, wherein if said calculated confidence is less than a minimum confidence required to proceed with said new IT service contract, calculating a price contingency to be added to a price of said new IT service contract to raise the calculated confidence to the minimum confidence.

23. The computer program storage medium of claim 21, wherein data associated with the set of historical IT service contracts includes contract risk data and percent gross profits.

24. The computer program storage medium of claim 22, wherein calculating a confidence of achieving expected gross profit x comprises calculating
$$Φ ( x ) = \frac{1}{\sqrt{2 π} σ} {\int }_{x}^{∞} exp ( - \frac{1}{2} {( \frac{x - μ}{σ} )}^{2} ) d x ,$$
wherein
$$p ( x ) = \frac{1}{\sqrt{2 π} σ} exp ( - \frac{1}{2} {( \frac{x - μ}{σ} )}^{2} )$$
is the probability distribution function, μ is a mean gross profit margin of the distribution, and σ is a standard deviation of the distribution, and calculating a price contingency comprises determining a value c wherein
$${Φ}^{′} ( x ) = \frac{1}{\sqrt{2 π} σ} {\int }_{x}^{∞} exp ( - \frac{1}{2} {( \frac{x - ( c + μ )}{σ} )}^{2} ) d x$$
is equal to the minimum confidence required to proceed with said new contract.
